(19) United States
(12) Patent Application Publication
(10) Pub. No.: US 2007/0047275 A1
(43) Pub. Date: Mar. 1, 2007

(54) Bipolar power supply with lossless snubber

(76) Inventors: Bryce L. Hesterman, Fort Collins, CO (US); Milan Ilic, Fort Collins, CO (US); Andrev B. Malinin, Fort Collins, CA (US)

Correspondence Address: JOHN D. PIRNOT;ADVANCED ENERGY INDUSTRIES, INC., 1625 SHARP POINT DR., FORT COLLINS, CO, 80525, US

(21) Appl. No.: 11/215,878

(22) Filed: Aug. 30, 2005

(51) Int. Cl. H02M 3/24

(52) U.S. Cl. 363/95

(57) ABSTRACT

In one aspect of the invention, an isolated power converter suitable for high power and high voltage applications comprises stacked rectifiers and lossless snubber circuits with inductors that prevent snubber diodes from delivering large current pulses into output filter capacitors when the duty cycle of the inverter is low, thereby allowing effective snubbing without unduly restricting the voltage conversion range of the power supply. In another aspect of the invention, control circuitry of a power supply comprises both a high bandwidth input current regulator and a low bandwidth output voltage regulator. The combination of a wide bandwidth input current regulator and a low bandwidth output voltage regulator allows the power supply to emulate an inductively loaded uncontrolled rectifier while restricting negative input impedance characteristics to frequencies that are substantially lower than the frequency of the ac power system.

### BACKGROUND OF THE INVENTION

1. Field of the Invention

This invention relates generally to switch mode power converters, and more particularly, to dc power converters suitable for high power and high voltage applications such as plasma processing.

1. Brief Description of the Prior Art

A common problem with isolated dc power converters in which the output of transformer windings is rectified and filtered with an inductor is that the rectifiers require some type of snubbing circuit to prevent energy that is built up in various circuit inductances during the reverse recovery of the rectifier diodes from causing the diodes to suffer reverse breakdown from voltage overshoots that occur in the transformer windings when the rectifier diodes turn off and the stored inductive energy is released. This problem is often handled by directing the stored energy away from the rectifiers with a snubber circuit. Snubbers that are connected to transformer isolated output circuits are commonly called secondary snubbers.

There are two main categories of snubber circuits, dissipative and lossless. Dissipative snubbers direct the stored energy into resistors. Dissipative snubbers are often impractical in high power converters, and so a variety of lossless snubber circuits have been developed. Lossless snubbers direct the stored energy back to the converter input, the converter output, or a combination of the two. Lossless snubbers are constructed with components that are ideally lossless such as diodes, active switches, capacitors and inductors. In practice, however, so-called lossless snubbers do have some power losses, but they are much lower that the power losses of dissipative snubbers.

A secondary snubber using an active switch is described in Jung-Goo Cho et al., “Zero-voltage and zero-current-switching full-bridge PWM converter using secondary active clamp,” IEEE Transactions on Power Electronics, vol. 13, no. 4, Jul. 1988, pp. 601-607. Having active components in snubbing circuits adds cost and complexity to ower converters, so it is often preferable to use passive snubbers. A variety of passive secondary snubbers are described in Jung G. Cho et al., “Novel zero-voltage and zero-current-switching (ZVZCS) full-bridge PWM converter using a simple auxiliary circuit,” Proceedings of the IEEE 1998 Applied Power Electronics Conference and Exposition (APEC), vol. 2, pp. 834-839.

It is often desirable to use stacked output rectifier circuits power supplies with high output voltages. The structure of stacked rectifiers may provide opportunities to employ types of snubber circuits that could not otherwise be implemented in power converters. An example of this is a particularly simple snubber circuit for a power converter with stacked output rectifiers is disclosed in Ashish Bendre, “New High Power DC-DC Converter with Loss Limited Switching and Lossless Secondary Clamp,” Proceedings of the IEEE 2001 Power Electronics Specialists Conference (PESC), vol. 1, pp. 321-326. This prior art power converter circuit is illustrated in FIG. 1.

In FIG. 1, a bipolar power supply BPS has a conventional phase shifted bridge inverter PSB that supplies ac power to bridge rectifiers RCTA and RCTB. Filter inductors LFA and LFB smooth the ripple in the currents supplied to filter capacitors CFA and CFB. This type of converter usually operates in continuous conduction mode, which means the currents in the filter conductors flow continually instead of being interrupted during each switching cycle. The diodes in the rectifiers operate in a freewheeling mode during the intervals of the switching cycle when the phase-shifted bridge PSB inverter is not supplying power. When the inverter begins to supply power to the rectifiers, the rectifier diodes turn off and snubber diodes DSA and DSB clamp the rectifier bridge voltages to the total output voltage between positive output terminal PT and negative output terminal NT.

Although this snubbing scheme is simple and effective, it has the disadvantage of limiting the allowable operating range of the inverter duty cycle to values somewhat greater than 0.5 in order to prevent the snubber diodes DSA and DSB from delivering large current pulses to the output filter capacitors CFA and CFB. This effect limits the available range of voltage conversion ratios obtainable with this power converter circuit.

A further challenge in the design of high power dc power converters is achievement of an acceptable power factor. Many power supplies that operate from three-phase ac power systems have a dc input bus connected across a large bulk energy storage filter capacitor to a three-phase rectifier bridge. While the approach is low-cost, the power factor is low, and high harmonic currents are drawn from the ac power system as a result of input current spikes produced as the filter capacitor is charged near the peaks of the ac line-line voltages. Active rectifier circuits have been devised to convert three-phase ac power to dc with a high power factor and low harmonics, as described for example in Bhim Singh et al., “A Review of Three-Phase Improved Power Quality AC-DC Converters,” IEEE Transactions on Industrial Electronics, Vol. 51, No. 3, June 2004, pp. 641-660, but the circuits are complicated and costly.

In some applications, the power factor and harmonics of a simple inductively-loaded uncontrolled three-phase rectifier are adequate. The simplest inductively-loaded three-phase rectifier circuit has a six-diode three-phase bridge rectifier with a filter inductor inserted between the bridge rectifier output and the bulk storage filter capacitor. The filter inductor is typically large enough that the output current of the bridge rectifier is relatively constant under steady-state operating conditions. The size, cost and weight of the filter inductor, however, are significant disadvantages to this approach.

In another approach, use of a large filter inductor is avoided by connecting a dc-dc converter to the output of a three-phase bridge rectifier, while using only enough inductance and capacitance as required for filtering high frequency ripple, as shown for example in J. G. Cho et al., “High Power Factor Three Phase Rectifier for High Power Density AC/DC Conversion Applications,” IEEE APEC 1999, vol. 2, pp. 910-915. Power supplies using this approach, however, present a negative incremental impedance to the ac power system up to frequencies approaching the unity-gain crossover frequency of the dc-dc converter output regulation control loop, which is typically at least 1 kHz. Negative input impedance characteristic means that the input current decreases when the input voltage increases; the effect occurs in this situation because the dc-dc converter behaves as a nearly constant-power load up to frequencies approaching the unity-gain crossover frequency of the dc-dc converter output regulation control loop. Power supplies having negative input impedances are susceptible to oscillations with the impedance of the ac power system when the magnitude of the impedance of the ac power system approaches magnitude of the negative incremental input impedance. Because the impedances of the ac power system inductances increase with frequency, the likelihood of having oscillations is directly related to the bandwidth of the negative input impedance. An RC damper circuit placed across the output of the bridge rectifier can mitigate the negative impedance effects, but the damping circuit may be prohibitively lossy when high ac power system impedances are encountered.

It would be desirable if there were provided an isolated wide-range power converter suitable for high power and high voltage applications in which stacked rectifiers are snubbed with lossless snubbers circuits that do not unduly restrict the voltage conversion range. It would be further desirable if the converter exhibited high power factor, relatively low harmonics, and low sensitivity to ac power system impedances.

### SUMMARY OF THE INVENTION

The invention provides a power converter suitable for high power and high voltage applications. In one aspect of the invention, a power supply comprises a power converter having rectifiers snubbed with one or more lossless snubber circuits that do not unduly restrict the voltage conversion range. The high output voltage capability, wide output voltage range, and low output capacitance of the power supply makes it well suited for high power and high voltage applications.

In one embodiment, a power supply has a positive output terminal, a negative output terminal, and a common output terminal. A first rectifier circuit receives ac power from an inverter and delivers dc power between a first positive rectifier terminal and a first negative rectifier terminal, and a second rectifier circuit receives ac power from the inverter and delivers dc power between a second positive rectifier terminal and a second negative rectifier terminal. The first positive rectifier terminal is connected to the positive output terminal, and the second negative rectifier terminal is connected to the negative output terminal. A first filter inductor is connected between the first negative rectifier terminal and the common output terminal, and a second filter inductor is connected between the second positive rectifier terminal and the common output terminal. Filter capacitors are connected between the output terminals and the common output terminal.

Lossless snubber circuits are connected between the power supply output terminals and the rectifier terminals. In one embodiment of the invention, first snubber inductor is connected between the positive output terminal and a first snubber junction, and a second snubber inductor is connected between the negative output terminal and a second snubber junction. A first snubber capacitor is connected between the first snubber junction and an output terminal, and a second snubber capacitor is connected between the second snubber junction and an output terminal. A first snubber diode is connected between the second positive rectifier terminal and the first snubber junction, and a second snubber diode is connected between the second snubber junction and the first negative rectifier terminal. The snubber diodes are oriented such that current flows into one snubber circuit while a balanced current flows out of the other snubber circuit. The snubber inductors prevent the snubber diodes from delivering large current pulses into the filter capacitors when the duty cycle of the inverter is low, thereby allowing effective snubbing without unduly restricting the voltage conversion range of the power supply.

In a further aspect of the invention, a power supply comprises power converter and control circuitry. In one embodiment of the invention, the control circuitry comprises both a high bandwidth input current regulator and a low bandwidth output voltage regulator. The input current regulator forms an input current control loop having that compares an input current signal to a current setpoint signal and provides a control signal to a control input of the power converter. The output voltage regulator forms an output voltage control loop that determines the current setpoint signal to the input current regulator with a bandwidth substantially less than that of the ac power line frequency. The combination of a wide bandwidth input current regulator and a low bandwidth output voltage regulator allows the power supply to emulate an inductively loaded uncontrolled rectifier.

### BRIEF DESCRIPTION OF THE DRAWINGS

FIG. 1 illustrates a prior art bipolar power supply with a simple lossless snubber circuit.

FIG. 2 illustrates a bipolar power supply with lossless snubbers in accordance with one embodiment of the invention.

FIG. 3 illustrates waveforms of the power supply of FIG. 2 when the inverter has a duty cycle of 0.7.

FIG. 4 illustrates waveforms of the power supply of FIG. 2 when the inverter has a duty cycle of 0.4.

FIG. 5 illustrates a power supply having control circuitry in accordance with one embodiment of the invention.

### DETAILED DESCRIPTION OF THE INVENTION

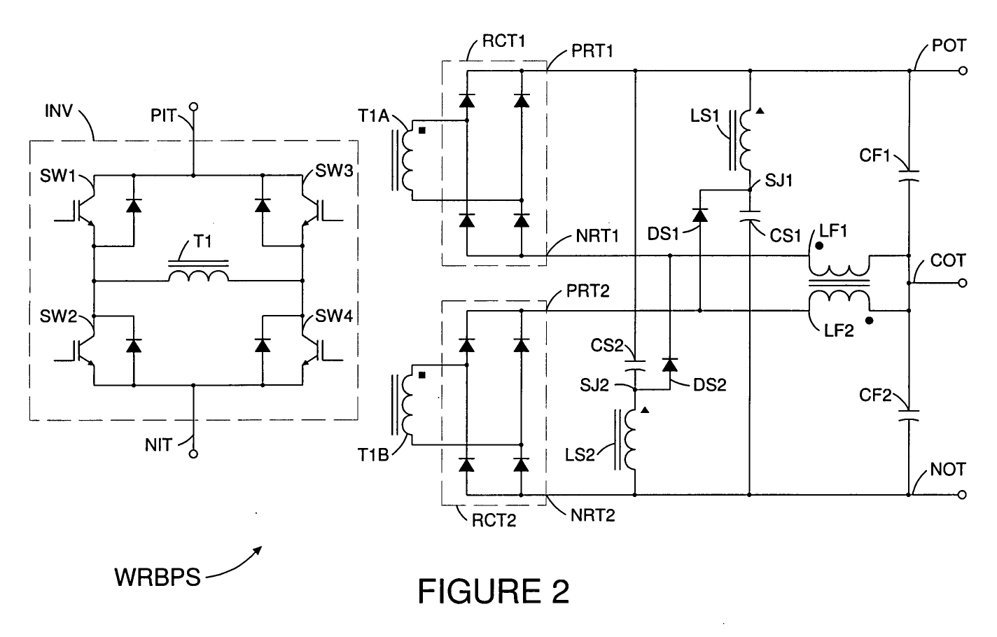

FIG. 2 illustrates a wide range bipolar power supply in accordance with one embodiment of the invention. Bipolar power supply WRBPS has an inverter INV that receives dc power from input terminals PIT and NIT. The inverter has switches SWI-SW4 that drive a transformer T1. The switches may be operated by a control circuit (not shown) so that the inverter functions as a phase shifted bridge or as a pulse width modulated H bridge. Inverter INV may also be implemented with any known inverter circuit that delivers current pulses into a transformer. Transformer T1 has secondary windings T1A and T1B that supply ac power to bridge rectifiers RCT1 and RCT2. Alternatively, T1 could be replaced with two transformers that serve the same function as T1. Rectifier RCT1 delivers dc power between a positive output terminal PRT1 and a negative output terminal NRT1. Rectifier RCT2 delivers dc power between a positive output terminal PRT2 and a negative output terminal NRT2. Rectifiers RCT1 and RCT2 may be implemented with other known rectifier circuits, for example, center-tapped full-wave rectifiers, and half-wave rectifiers such as those used in forward converters and flyback converters.

Power supply WRBPS has a positive output terminal POT, a negative output terminal NOT, and a common output terminal COT. Positive rectifier terminal PRT1 is connected to the positive output terminal POT, and negative rectifier terminal NRT2 is connected to negative output terminal NRT2. A filter inductor LF1 is connected between negative rectifier terminal NRT1 and the common output terminal COT. A second filter inductor LF2 is connected between positive rectifier terminal PRT2 and the common output terminal. An output filter capacitor CF1 is connected between the positive output terminal and the common output terminal, and a second output filter capacitor CF2 is connected between the negative output terminal and the common output terminal. Filter inductors LF1 and LF2 smooth the ripple in the currents supplied to filter capacitors CF1 and CF2.

A snubber inductor LS1 is connected between the positive output terminal and a snubber junction SJ1, and a second snubber inductor LS2 is connected between the negative output terminal and a second snubber junction SJ2. A snubber capacitor CS1 is connected between the snubber junction SJ1 and the negative output terminal, and a second snubber capacitor CS2 is connected between the second snubber junction and the positive output terminal. The snubber capacitor connections shown in FIG. 2 generally produce the least ripple current in the output filter capacitors, but the snubber capacitors could also be connected to any of the output terminals, preferably in a symmetrical manner. For example, CS1 could have one end connected to the positive output terminal, and CS2 could have one end connected to the negative output terminal. Alternatively, both CS1 and CS2 could each have one end connected to the common output terminal.

A snubber diode DS1 is connected between positive rectifier terminal PRT2 and the snubber junction SJ1, and a second snubber diode DS2 is connected between snubber junction SJ2 and negative rectifier terminal NRT1. The snubber diodes are oriented such that when they conduct current in the forward direction, the current in DS1 flows into snubber junction SJ1, and the current in DS2 flows out of junction SJ2.

Secondary windings T1A and T1B are preferably wound in a way that they produce essentially equal voltages and identical waveforms between the rectifier output terminals of rectifiers RCT1 and RCT2. If these rectifiers are implemented using full-wave rectifier circuits, then the polarities of the secondary windings are not important. If, however, rectifiers RCT1 and RCT2 are implemented using half-wave rectifier circuits, then the secondary winding polarities should be as indicated in FIG. 2. If the secondary windings are implemented so that the output voltages of rectifiers RCT1 and RCT2 are nearly equal, then the two snubber inductors LS1 and LS2, and the two filter inductors LF1 and LF2 may be coupled as shown in FIG. 2. The snubber capacitors CS1 and CS2 should preferably have equal capacitances, and it is also preferable that filter capacitors CF1 and CF2 have equal capacitances.

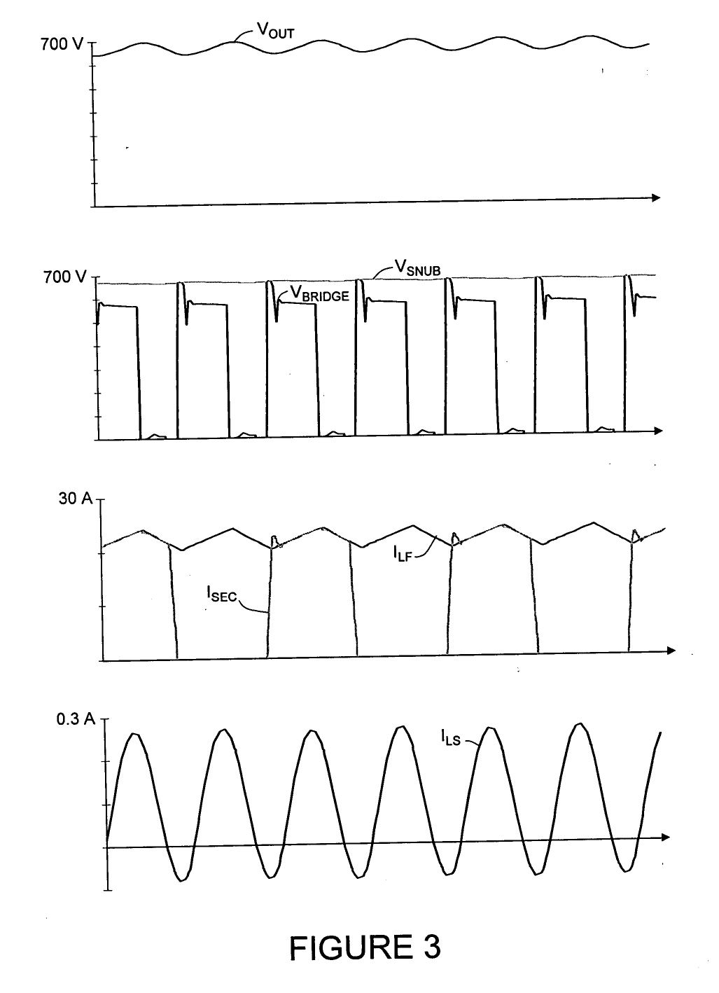

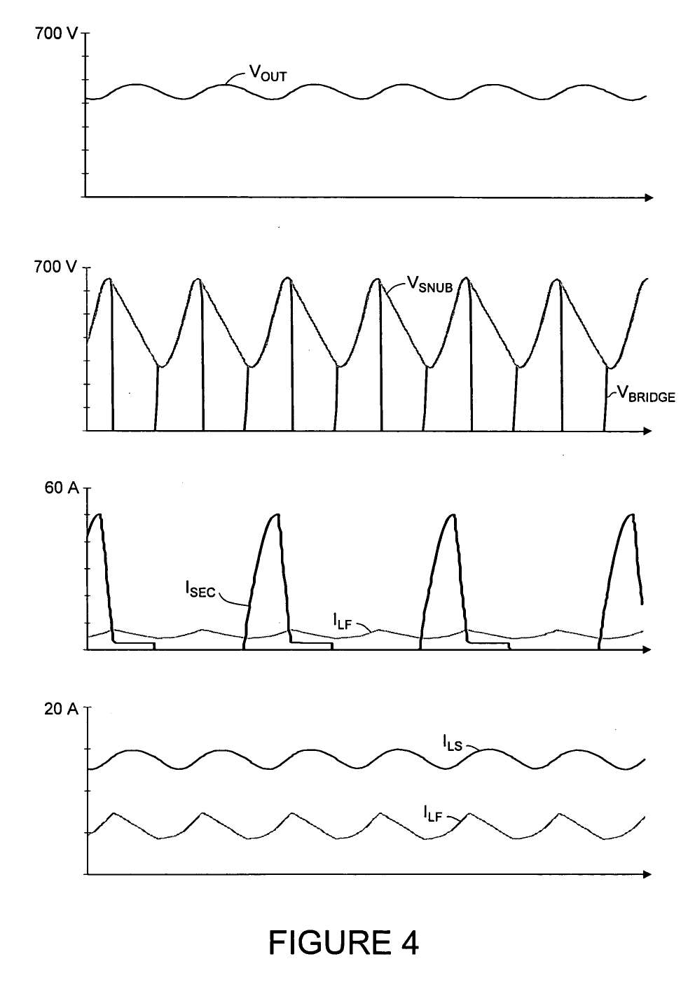

FIGS. 3 and 4 illustrate waveforms of power supply WRBPS when the inverter is operating with a duty cycles of 0.7 and 0.4, respectively. The waveforms were produced by computer simulations with the component values and parameters specified in Table 1. Table 2 lists operating performance parameters.

In FIGS. 3 and 4, V_{OUT} is the output voltage between the positive and negative output terminals, V_{BRIDGE} is the voltage between each set of positive and negative rectifier terminals, and V_{SNUB} is the voltage across the snubber capacitors. I_{LF} is the current flowing out of the dotted ends of filter inductors LF1 and LF2, and I_{LS} is the current flowing out of the dotted ends of snubber inductors LS1 and LS2. I_{SEC} is the current flowing out of the dotted ends of secondary windings T1A and T1B.

TABLE 1
Component values and parameters for FIG. 2.

| | | |
|---|---|---|
| Transformer winding inductances | 1 | mH (all three windings) |
| Transformer coupling coefficients | 0.99 | (all three couplings) |
| Filter inductors LF1 and LF2 | 300 | μH |
| Coupling between LF1 and LF2 | 0.97 | |
| Snubber inductors LS1 and LS2 | 200 | μH |
| Coupling between LS1 and LS2 | 0.99 | |
| Snubber capacitors CS1 and CS2 | 330 | nF |
| Output filter capacitors CF1 and CF2 | 330 | nF |

TABLE 2
Operating parameters for FIGS. 3 and 4.

| | | | | |
|---|---|---|---|---|
| Operating frequency | 31.25 | kHz | 31.25 | kHz |
| Input voltage | 500 | V | 500 | V |
| Output power | 15 | kW | 15 | kW |
| Inverter duty cycle | 0.7 | | 0.4 | |
| Average output voltage | 668 | V | 451 | V |

| | | |
|---|---|---|
| Percent rms output ripple voltage | 2.7% | 5.0% |

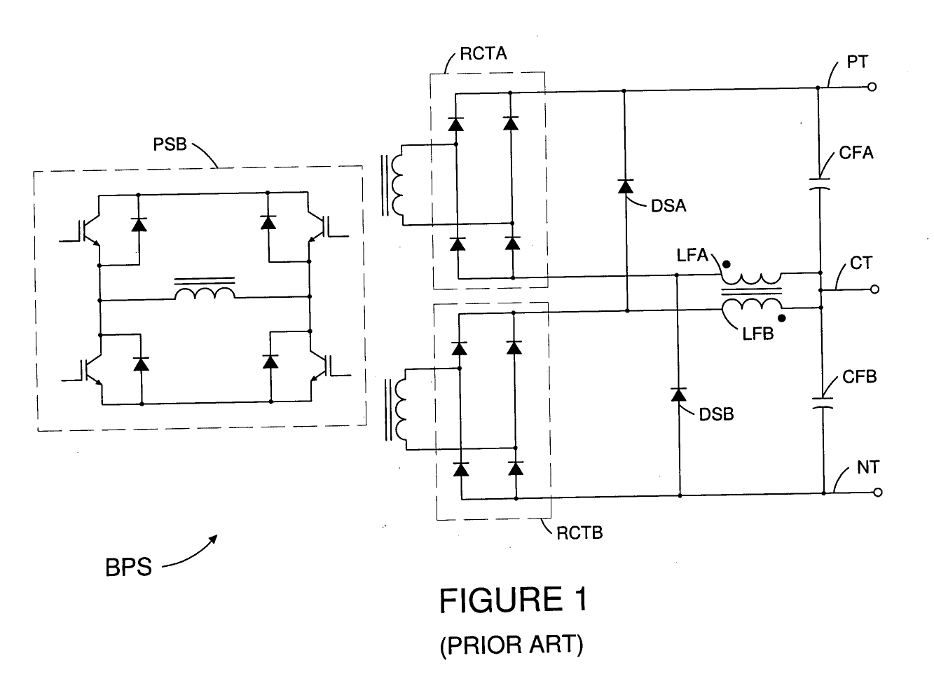

FIG. 3 illustrates waveforms of power supply WRBPS in FIG. 2 when inverter INV is operating with a duty cycle of 0.7. The snubber diodes will conduct very little current when the peak-to-average ratio of the voltages between the output terminals of rectifiers RCT1 and RCT2 is less than two, and the snubber voltage VSNUB will be approximately equal to the peak value of the bridge voltage. This condition will be met when the duty cycle of a square-wave inverter such INV is somewhat greater than 0.5. The duty cycle of the rectifier output voltages will be smaller than the duty cycle of the inverter due to transformer leakage inductance. The prior art power supply BPS in FIG. 1 operates in a similar manner when the inverter duty cycle is high.

FIG. 4 illustrates waveforms of power supply WRBPS in FIG. 2 when inverter INV is operating with a duty cycle of 0.4. The snubber diodes may conduct substantial current when the peak-to-average ratio of the voltages between the output terminals of rectifiers RCT1 and RCT2 is greater than two. This condition will be met when the duty cycle of a square-wave inverter such RNV is less than about 0.5. This is also true for the prior art power supply BPS in FIG. 1. The peak values of the currents flowing through snubber diodes DS1 and DS2 are limited by snubber inductors LS1 and LS2, as shown by waveform I_{LF}. The bottom plot of FIG. 4 shows that the currents through the snubber inductors are the greater than currents through the filter inductors, but the ripple in the output voltage is still relatively low.

The peak value of the snubber capacitor voltage V_{SNUB} is about the same in FIGS. 3 and 4, but the ripple voltage is much greater in FIG. 4. Even so, the volt-ampere product of the snubber capacitor ac voltages and currents is only about 2.5 kVA, which is still small in comparison to the 15 kW output power. The optimal values of the snubber capacitors depend on the application. For example, the capacitor values listed in Table 2 are suitable for a power supply that is used to deliver power to a plasma load.

The WRBPS power supply circuit could also be used in applications where the bipolar output voltage capability is used. An example of this would be to use it as a pre-regulator power supply for creating a stable isolated dc bus voltage from a rectified three-phase voltage. The pre-regulator would supply power to a stacked power converter that has three corresponding input terminals such as the soft switching stacked buck power converter described in co-pending patent application “Soft Switching Interleaved Power Converter,” filed Aug. 24, 2004. DC inverter input terminals PIT and NIT would receive power from the output voltage of a three-phase bridge rectifier. In this application, the wide voltage conversion range would be used to accommodate changes in the ac input voltage. The output capacitors would preferably be much larger, on the order of a few hundred microfarads, to provide bulk energy storage that would enhance the ability to ride thought power line transients. The control circuitry for the inverter (not shown) should be designed to draw a relatively constant current from the bridge rectifier while maintaining a relatively stable output voltage. Such a control circuit would have an inner input-current control loop with a bandwidth of a few kHz, and an outer control loop that would have a bandwidth substantially less than the ac power line frequency to regulate the isolated dc bus output voltage.

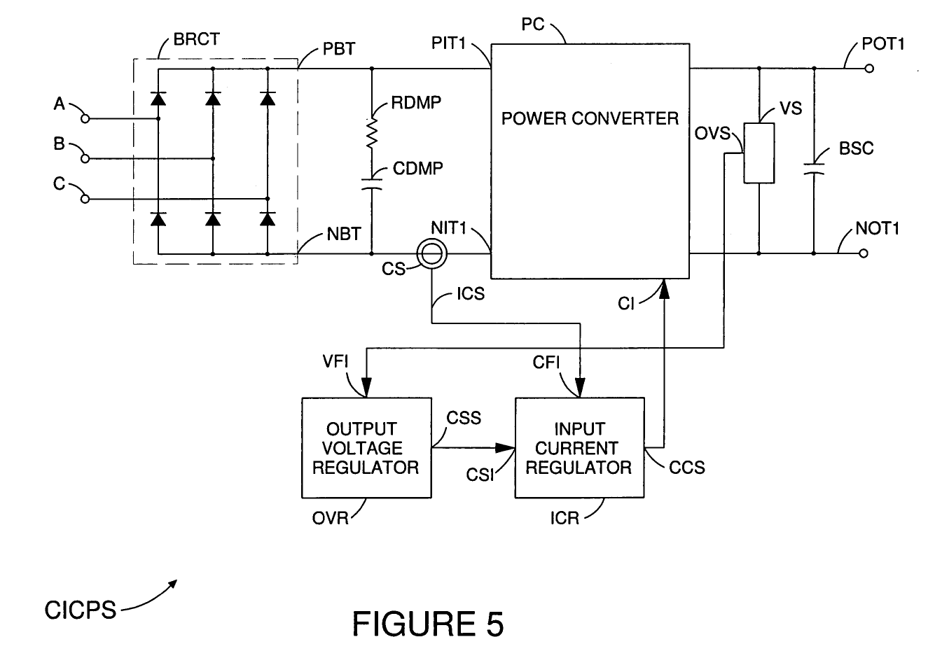

FIG. 5 illustrates a power supply having control circuitry in accordance with one embodiment of the invention. Power supply CICPS has a dc-dc power converter PC that draws a relatively constant dc input current under typical operating conditions from the dc output of a three-phase bridge rectifier BRTC through a positive bridge output terminal PBT, and a negative bridge output terminal NBT. The three-phase bridge rectifier is connected to a three-phase ac power system at terminals A, B, and C. A damping resistor RDMP and a damping capacitor CDMP are connected in series across the output terminals of the three-phase bridge. The ac power system may be any polyphase ac system having at least three phases. The bridge rectifier may alternatively be any uncontrolled polyphase rectifier circuit suitable for a particular polyphase ac system.

Power converter PC has dc input terminals PIT1 (positive) and NIT1 (negative) connected to the bridge output terminals of corresponding polarity, and dc output terminals POT1 and NOT1. The power flow through the power converter is controlled by a control input CI. The dc-dc converter may be realized with power supply WRBPS, or any other controllable dc-dc converter suitable for the voltage and power levels of a particular application.

A bulk storage capacitor BSC is connected between the dc output terminals for ride-through capability for ac line transients. If power supply WRBPS of FIG. 2 is used, for example, then CF1 and CF2 may each be a combination of a high-frequency filter capacitor and a bulk storage capacitor.

Referring again to FIG. 5, a voltage sensor VS provides a signal OVS that is proportional to the output voltage of the power converter. This signal is applied to a voltage feedback input VFI of an output voltage regulator OVR. The output voltage regulator compares the output voltage signal to a pre-determined output voltage setpoint value, and provides a current setpoint signal CSS to a current setpoint input CSI of an input current regulator ICR. A current sensor CS provides an input current signal ICS that is proportional to the input current of the power converter a current feedback input of the input current regulator. The input current regulator compares the input current signal to the current setpoint signal and provides a converter control signal CCS to the control input CI of the power converter.

The input current regulator forms an input current control loop that preferably has a unity-gain bandwidth of a few kHz (e.g. 3 kHz), and the output voltage regulator forms an output voltage control loop that preferably has a unity-gain bandwidth that is substantially less than the ac power line frequency (e.g. 20 Hz for ac line frequencies of 50-60 Hz). The voltage and current control loops of the CICPS power supply are implemented either with analog control circuits or as programmed equations within a digital controller. The bandwidths of the control loops are determined by the values of compensation network components when analog control circuits are used, and by equation coefficients when a digital controller is used.

The combination of a wide bandwidth input current regulator and a low-bandwidth output voltage regulator allows the CICPS power supply to approximately emulate an inductively-loaded uncontrolled rectifier. The real part of the closed-loop input impedance of the power converter PC is positive for frequencies above the closed-loop unity-gain bandwidth of the voltage control loop, which is substantially less than the ac power system frequency. The ac power system impedances are generally quite low at the frequencies where the closed-loop input impedance of the power converter PC is negative. Consequently, this power supply is relatively insensitive to the impedance of the ac power system.

The emulation of the inductively-loaded uncontrolled rectifier is imperfect, however, because the closed-loop input impedance of the power converter tends to be somewhat capacitive, and it can resonate with the impedance of power line inductance as it is reflected through the bridge rectifier. Damping resistor RDMP and damping capacitor CDMP form an RC damping network for the output of the bridge rectifier. The amount of damping required, and the attendant losses, are far less than those required for damping the negative impedances of prior art circuits.

The output voltage of the CICPS power supply will have ripple at the ripple frequency of the output of the three-phase bridge rectifier due to the low bandwidth of the output voltage control loop. The magnitude of the output voltage ripple will be reduced in accordance with the value of the bulk storage capacitor BCS.

The CICPS power supply is particularly suited for applications where output voltage ripple is not a problem, such as a pre-regulator for another power supply that needs to provide a constant output power. In that case, the bulk storage capacitance must store enough energy to allow the output power supply to deliver a constant output power while because the power delivered by the power converter to the bulk storage capacitance can fluctuate due to the low bandwidth of the voltage control loop.

When the CICPS power supply is used as a pre-regulator, the load transient response is improved by utilizing a power demand feedforward signal (not shown) provided by the loading power supply (not shown).

Although specific structure and details of operation are illustrated and described herein, it is to be understood that these descriptions are exemplary and that alternative embodiments and equivalents may be readily made by those skilled in the art without departing from the spirit and the scope of this invention. Accordingly, the invention is intended to embrace all such alternatives and equivalents that fall within the spirit and scope of the appended claims.

What is claimed is:

1. A power supply for delivering power a load comprising:
a) a bridge rectifier that rectifies power from a polyphase ac power system having an ac power system frequency to a dc input voltage and dc input current;
b) a dc-dc converter that converts the dc input voltage and dc input current to a power output at a dc output voltage and dc output current, the dc-dc converter receiving a control input signal for controlling the power output of the dc-dc converter;
c) an output voltage regulator that determines a current setpoint signal in response to the dc output voltage, the output voltage regulator comprising an output voltage control loop having a unity-gain bandwidth that is substantially less than the ac power system frequency; and
d) an input current regulator that determines the control input signal in response to the current setpoint signal, the input current regulator comprising an input current control loop having a unity-gain bandwidth that is substantially greater than the ac power system frequency.

2. The power supply of claim 1, further comprising a current sensor that measures the dc input current.

3. The power supply of claim 2 wherein the current sensor provides an input current signal to the input current regulator, and wherein the input current regulator compares the input current signal to the current setpoint signal to determine the control input signal.

4. The power supply of claim 1 wherein the output voltage and input current control loops are implemented with digital controllers.

5. The power supply of claim 1 wherein the dc-dc converter comprises one or more lossless snubber circuits that prevent snubber diodes from delivering substantial current pulses into one or more output filter capacitors of the dc-dc converter.

6. The power supply of claim 1, further comprising a bulk storage capacitor disposed across output terminals of the dc-dc converter.

7. The power supply of claim 1, further comprising a damping network disposed across the output of the bridge rectifier.

8. The power supply of claim 1 wherein the dc-dc converter receives a second control input signal from a loading power supply for further controlling the power output of the dc-dc converter.

9. A method of delivering power to a load comprising:
a) rectifying power from a polyphase ac power system having an ac power system frequency to a dc input voltage and dc input current;
b) converting the dc input voltage and dc input current to a power output at a dc output voltage and dc output current using a dc-dc converter;
c) deriving a current setpoint signal using the dc output voltage at a unity-gain bandwidth that is substantially less than the ac power system frequency;
d) deriving a control input signal using the current setpoint signal at a unity-gain bandwidth that is substantially greater than the ac power system frequency; and
e) controlling the power output of the dc-dc converter using the control input signal.

10. The method of claim 9, further comprising the step of comparing the dc input current to the current setpoint signal to derive the control input signal.

11. The power converter of claim 9, further comprising the steps of receiving a second control input signal from a loading power supply and further controlling the power output of the dc-dc converter using the second control input signal.
